(19) United States
(12) Patent Application Publication
(10) Pub. No.: US 2017/0192465 A1
(43) Pub. Date: Jul. 6, 2017

(54) APPARATUS AND METHOD FOR DISAMBIGUATING INFORMATION INPUT TO A PORTABLE ELECTRONIC DEVICE

(71) Applicant: Infinite Potential Technologies LP, Waterloo (CA)

(72) Inventors: Mihal Lazaridis, Waterloo (CA); Mark Pecen, Waterloo (CA)

(73) Assignee: Infinite Potential Technologies LP, Waterloo, ON (CA)

(21) Appl. No.: 15/314,787

(22) PCT Filed: May 29, 2015
(86) PCT No.: PCT/IB2015/001719

§ 371 Date: Nov. 29, 2016

Related U.S. Application Data
(60) Provisional application No. 62/005,892, filed on May 30, 2014.

(51) Int. Cl. G06F 1/16; G06F 3/0484; G06F 3/0487; G06F 3/01

(52) U.S. Cl. CPC G06F 1/1662; G06F 3/017; G06F 3/0484; G06F 1/1694; G06F 3/0487

(57) ABSTRACT

An electronic device with multiple user interfaces configured such that more than one interface ambiguously responds to a user gesture intended as input to the device. To remove ambiguity, the device may operate in one of a plurality of input modes, in which outputs of different ones of the user interfaces are selectively processed. The user input mode may be specified by a user such that the device unambiguously responds to a gesture as intended. The device may be a portable electronic device with closely spaced user interfaces that each respond to a user gesture near the device. The device may be a portable electronic device with non-contact sensors that detect a user gesture in a three dimensional space above a surface of the device. Such a device may distinguish such gestures, intended as navigational information, from gestures associated with location-based or other types of inputs.

### BACKGROUND

Electronic devices, such as smartphones, tablets and personal computers, have user interfaces through which a user may input information or commands. Each user interface may respond to different actions by a user and generate information indicating a user action detected. The output of the user interface may be processed in a component, such as an operating system, on the electronic device, to provide some indication of what the user input signifies. The operating system may route those indications to a program executing on the electronic device, which then responds to the user input based on what it signifies in the context of that application.

A common user interface is a keyboard. A typical personal computer may have a full-size keyboard organized in a typewriter layout (QWERTY), although other key arrangements may be used. A smaller electronic device (e.g. a mobile telephone, handheld computer or smartphone) may have a miniature keyboard integrated as part of the electronic device. A keyboard may be an external keyboard as an added component that connects to a computer, such as in a typical desktop computer arrangement. Alternatively, the keyboard may be integrated as part of a device, such as in a laptop computer.

A keyboard has a finite number of keys and is typically operated by a user's hands. The user utilizes their fingers to activate keys by touching and/or pressing them. The keyboard provides an output indicating which keys were activated. That indication may be passed on by the operating system to an application program executing on the device. Such a keyboard may be convenient for text data input by a user when each key corresponds to a text character.

A mouse is another user interface. The mouse is used in conjunction with information presented on a display and a cursor, indicating a location on the display. When a user moves the mouse, it provides an output indicating direction and amount of motion of the cursor location. When another user input, representing a selection, is received the operating system interprets that as an instruction to perform an operation that is dependent on what information is displayed on the screen at the cursor location.

A mouse is often used for a stationary computer because space is required next to the computer to move the mouse. A similar user input experience may be provided with a touchpad on a laptop computer. By touching the pad with a finger, and moving the finger, a user may signify motion. That motion may similarly change the location of a cursor and, as with a mouse, an operation dependent on the location of the cursor may be performed when a selection input is provided.

Another user interface is a touchscreen. A touchscreen includes a visual display on which a program executing on the electronic device can present information. A user can provide input by touching the screen, typically with the user's fingers. The touchscreen responds to the input by providing an indication of where the screen was touched. The operating system of the electronic device may correlate the indication of where the user touched the touch screen to what information was being displayed at that time. Depending on the nature of the contact with the touch screen and/or the information displayed on the touch screen at the location of that contact, the output of the touch screen may be interpreted differently.

The touch screen, for example, may be configured with graphics representing keys. When the user contacts the touch screen at a location occupied by a display of a key, the electronic device may respond just like it would to a user input through a keyboard designating the same key. A computer configured in this way may be said to have a virtual keyboard.

In some instances, the locations of contact over time may be interpreted as a gesture, which is the input. The gesture may be recognized by the operating system and provided to an application program executing on the device. In some instances, a gesture may be interpreted, either by the application or the operating system, as navigation information.

Navigation information, for example, may have meaning when there is at least one dimension associated with information on the display. As an example of data with one dimension, a display may include data values around the circumference of a wheel. The user may make a gesture involving sliding a finger across the touch screen. The gesture may be interpreted as an indication that the wheel should be rotated in a specific direction so that different data is visible on the wheel.

As an example of data with two dimensions, a portion of a large data table may be displayed. The user may make a gesture involving sliding a finger across the touch screen. The gesture may be interpreted as input to “pan” over the table such that a new portion of the table is displayed. In this scenario, the gesture indicates the direction of the new portion to be displayed relative to the currently displayed portion.

As an example of data with three dimensions, a photo may be displayed. Gestures interpreted as input to pan over the photo may be made. In addition, the user may make a gesture involving bringing together or separating two points of contact on the touch screen. Such gestures are sometimes called “pinching” or “spreading.” These gestures may be interpreted as an indication that display of the photo may be zoomed in or out. This zooming may be regarded as signifying a direction corresponding to getting closer to or further from the display.

These types of input gestures can be referred to as “navigational inputs.” In this context, “navigation” is relevant when some aspect of the information displayed has a state-space with dimensions. All or a part of that state-space is represented in a physical coordinate system with one or more dimensions of the information correlated to one or more dimensions of the display. As a result, gestures, indicating traversal of a dimension associated with a display, can be interpreted as traversal of a corresponding dimension of the data to alter what information is displayed.

A touchscreen enables a user to interact directly with what is displayed and allows a user to view content in the same space in which navigational input is acquired. On a small, portable electronic device, a touchscreen provides benefits, such as removing the need for a mouse or a touchpad to provide navigational input, simplifying the overall design of an electronic device. Combining display of information with the navigational user interface of a device is particularly useful when the size of the device is small. This approach is also particularly useful as interaction with computing devices becoming more graphical rather than text-based. For example, a user interface may receive user input of a selection of one of multiple options by a navigational gesture identifying an icon on a display associated with the selected option. Making such a gesture may be faster than typing keys to provide sufficient text to identify the selected option.

### SUMMARY

Described herein is an electronic device having multiple user input modes, such as a keyboard input mode, a touch-based navigational input mode, and/or a touchless navigational input mode. In accordance with some embodiments, a user gesture may be processed differently based on an input mode of the device. The device may respond to user input indicating a particular user input mode.

Accordingly, aspects of the present application may be embodied as an electronic device that is associated with a display. The electronic device may comprise a keyboard, at least one sensor, and at least one processor. The keyboard may comprise a plurality of keys and may be configured to generate keyboard output information based on a user making a gesture designating a key of the plurality of keys. The at least one sensor may be configured to generate sensor output information based on a user making a gesture in a three-dimensional space proximate to the keyboard. The at least one processor may be configured to select an operating mode of a plurality of operating modes based on mode-indicating input received from the user. The plurality of operating modes may comprise a keyboard input mode and a navigation mode. The at least one processor may be further configured to selectively respond to a user gesture based on the selected mode. When the keyboard input mode is selected, the at least one processor may modify information presented on the display based on generated keyboard output information associated with the user gesture. When the navigation mode is selected, the at least one processor may modify the information presented on the display based on sensor output information associated with the user gesture.

In some embodiments, an electronic device may be associated with a keyboard. The electronic device may comprise a keyboard, at least one touch sensor, at least one gesture recognition sensor, and at least one processor. The keyboard comprises a plurality of keys and is configured to generate keyboard output information based on a user making a gesture designating a key of the plurality of keys. The at least one touch sensor may be configured to generate touch-based information based on a user gesturing on a surface of the keyboard. The at least one gesture recognition sensor may be configured to generate three-dimensional gesture information based on a user making a gesture in a three-dimensional space proximate the keyboard. The at least one processor configured to select an operating mode of a plurality of operating modes based on a mode-indicating input received from the user. The plurality of operating modes may comprise a keyboard input mode, a touch-based input mode, and a gesture recognition input mode. The at least one processor may be further configured to selectively respond to a user gesture based on the selected mode. When the keyboard input mode is selected, the at least one processor may modify information presented on the display based on generated keyboard output information associated with the user gesture. When the touch-based input mode is selected, the at least one processor may modify information presented on the display based on touch-based information associated with the user gesture. When the gesture recognition input mode is selected, the at least one processor may modify information presented on the display based on three-dimensional information associated with the user gesture.

In some embodiments, a method of selecting an input mode for an electronic device operable in a plurality of input modes is provided. The electronic device may have a keyboard and a display. The method may comprise selecting an input mode of the plurality of input modes based on a user input. The plurality of input modes may comprise a keyboard input mode and a navigational mode. The method may further comprise responding, selectively, to a user gesture based on the selected mode. The responding may comprise, when the keyboard input mode is selected, adding to information presented on the display based on generated keyboard output information associated with the user gesture. The responding may further comprise, when the navigation mode is selected, modifying the information presented on the display based on non-contact sensor output information associated with the user gesture.

In some embodiments, a method of selecting an input mode for an electronic device operable in a plurality of input modes is provided. The electronic device may have a display. The method may comprise selecting an input mode of the plurality of input modes based on a user input. The plurality of input modes may comprise a location-based input mode and a gesture-based input mode. The method may further comprise responding, selectively, to a user activity based on the selected mode. The responding may comprise, when the location-based input mode is selected and the user activity designates a location on the device, modifying information presented on the display based on designated location information associated with the user activity. The responding may further comprise, when the gesture-based input mode is selected and the user activity is a gesture detected by a sensor, modifying information presented on the display based on generated sensor output information associated with the user activity.

In some embodiments, the method further comprises deselecting the location-based input mode when the gesture-based input mode is selected. In some embodiments, the location-based input mode and the gesture-based input mode are mutually exclusive. In some embodiments, the device has a keyboard and the method further comprises generating keyboard output information based on the user designating a key of a plurality of keys on the keyboard while in the location-based input mode and generating navigational information based on the user gesturing on a surface of the keyboard while in the gesture-based input mode. In some embodiments, the user input is a pressing of at least one key on the keyboard exceeding a threshold time. In some embodiments, the user input is received through a component residing on the device external to the keyboard. In some embodiments, the user input comprises a movement of the electronic device. In some embodiments, the user input comprises moving the electronic device to have a tilt with respect to an inertial coordinate system in a predetermined range of angles. In some embodiments, the method further comprise selecting, after a predetermined time, a second input mode of the plurality of input modes.

According to an aspect of the present application, an electronic device associated with a display is provided. The electronic device may comprise a keyboard comprising a plurality of keys. The keyboard may be configured to generate keyboard output information based on a user making a gesture designating a key of the plurality of keys. The electronic device may further comprise at least one sensor configured to generate sensor output information based on a user making a gesture on a surface of the device and at least one processor. The at least one processor may be configured to, based on mode-indicating input received from the user, select an operating mode of a plurality of operating modes. The plurality of operating modes comprises a keyboard input mode and a navigation mode. The at least one processor may be further configured to selectively respond to a user gesture based on the selected mode. When the keyboard input mode is selected, the at least one processor may modify information presented on the display based on generated keyboard output information associated with the user gesture. When the navigation mode is selected, the at least one processor may modify the information presented on the display based on sensor output information associated with the user gesture.

In some embodiments, the at least one sensor comprises at least one touch-based sensor and the at least one processor is further configured to generate navigational information based on the user touching the keyboard while in the navigation mode. In some embodiments, the at least one processor is further configured to receive the mode-indicating input via at least one key on the keyboard. In some embodiments, the at least one processor is further configured to receive the mode-indicating input via at least one button residing on the device external to the keyboard. In some embodiments, the at least one processor is further configured to deselect the keyboard input mode when the navigation mode is selected. In some embodiments, the keyboard input mode and the navigation mode are mutually exclusive. In some embodiments, the keyboard is on a surface of the device and the at least one sensor is within the device adjacent to the keyboard. In some embodiments, the at least one sensor is within the keyboard. In some embodiments, the at least one sensor comprises at least one of a plurality of resistive elements, a plurality of optical elements, and a plurality of capacitive elements.

In some embodiments, the display is a screen mounted on the device. In some embodiments, the display is a separate device. In some embodiments, the display is configured to be worn by a user. In some embodiments, the display is a heads-up display. In some embodiments, the keyboard is a physical keyboard. In some embodiments, the keyboard is a virtual keyboard. In some embodiments, the at least one sensor is integrally connected to the keyboard. In some embodiments, the electronic device is a smartphone. In some embodiments, the electronic device is a tablet.

In some embodiments, the electronic device further comprises an inertial sensor and the mode-indicating input comprises an output of the inertial sensor. In some embodiments, the at least one processor is further configured to select a default input mode after a duration of time based on a timer, the default input mode is set to at least one of the keyboard input mode and the navigation mode, and the timer is reset when at least one of the keyboard input mode and the navigation mode is selected by mode-indicating input received by the user.

According to an aspect of the present application, at least one non-transitory, tangible computer readable storage medium having computer-executable instructions, that when executed by a processor, perform a method of selecting an input mode for an electronic device operable in a plurality of input modes is provided. The electronic device may have a keyboard and a display. The method may comprise selecting an input mode of the plurality of input modes based on a user input, wherein the plurality of input modes comprises a location-based input mode and a navigation mode. The method may further comprise responding, selectively, to a user gesture based on the selected mode, the responding comprising. When the location-based input mode is selected, the method may comprise modifying information presented on the display based on designated location information associated with the user gesture. When the navigation mode is selected, the method may comprise modifying information presented on the display based on navigational sensor output information associated with the user gesture.

In some embodiments, the designated location information and the navigational sensor output information is based on the user touching the keyboard. In some embodiments, the generated location output information is keyboard output information based on the user gesture designating a key of a plurality of keys on the keyboard while in the location-based input mode. In some embodiments, the generated navigational sensor output information is based on the user gesture made on a surface of a keyboard associated with the device while in the navigation mode. In some embodiments, the user input is a pressing of at least one key on the keyboard exceeding a threshold time. In some embodiments, the user input is received through a component residing on the device external to the keyboard.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a sketch of an electronic device with a physical, integrated keyboard.

FIG. 1B is a cross section of the electronic device of FIG. 1A along line A-A′.

FIG. 1C is a cross section of an alternative embodiment of an electronic device with a physical, integrated keyboard.

FIG. 2A is a sketch of an electronic device with a virtual keyboard.

FIG. 2B is a cross section of the electronic device of FIG. 2A along line B-B′.

FIG. 2C is a cross section of an alternative embodiment of an electronic device with a virtual keyboard.

FIG. 3 is a block diagram of an electronic device operable in more than one input mode.

FIG. 4 is a state diagram illustrating operating modes of a device with a keyboard input mode and a navigational input mode.

FIG. 5 is a state diagram illustrating operating modes of a device with a keyboard input mode, a touch-based input mode, and a touchless input mode.

FIG. 6 is a sketch of a computing device that may operate on one or more user input modes.

### DETAILED DESCRIPTION

The inventors have recognized and appreciated that more flexible and intuitive operation of an electronic device may result from providing a mechanism for selecting an input mode for processing a user gesture that may be associated with more than one user interface. This approach may be particularly useful for portable electronic devices in which user interfaces are closely spaced such that more than one user interface may provide an output in response to a gesture made in the three dimensional space around the device. Accordingly, techniques as described herein may enable further size reduction and increased functionality in portable electronic devices. Further, such an approach may enable use of a touchless gesture-based input mode.

For example, the electronic device may have one or more sensors configured to detect user gestures, such as hand motion, in a three dimensional space. For a small electronic device, one or more such sensors may be integral with the device such that a sensor detects gestures adjacent the device. For example, when using a device with a keyboard, a user may move their hands to activate different keys. If those hand motions occur in the same space in which the sensors detect user gestures, the device may incorrectly interpret motion associated with using the keyboard with a gesture intended to represent a different type of user input through a different user interface. By providing a simple mechanism for a user to designate an input mode in which the electronic device is to operate, the gesture may be unambiguously associated with an intended user interface.

Equipping an electronic device with a capability to operate in a specified user input mode may enable devices with multiple user interfaces. Such a device may be compact. For example, the device may have a keyboard that may, in some user input modes, generate outputs indicating user gestures that may serve as navigational input. As a specific example, the keyboard may have sensors that, in a keyboard input mode, provide output indicating which key was activated by a user. In another input mode, the output of those same sensors may indicate a gesture by tracking motion of the user's hand in space above the device. That gesture may represent navigational information.

Alternatively or additionally, the keyboard may have different sensors to detect activation of a key or a gesture, such as may indicate navigational input. For example, the keyboard may include embedded proximity sensors, different from any sensors that indicate activation of a key on the keyboard, that provide output indicating a gesture made above the keyboard. Accordingly, either a touchless or touch-based sensor may serve as a navigational sensor, providing outputs that are interpreted as navigation information, depending on how its output is subsequently processed.

Integrating into a single device, or at least closely spacing, keyboard and three-dimensional gesture-based user interfaces may be desirable in a portable electronic device that has a limited amount of space for user interfaces. Such portable electronic devices may include smart phones, tablets, laptop computers, and personal digital assistants (PDAs). Some of these electronic devices are designed to be hand-held and/or easy to carry by a user. Dimensions of such portable electronic devices cover a range of widths, heights, and screen sizes. In some embodiments, dimensions for a smart phone may be in the range of 2 inches to 3 inches in width by 4 inches to 6 inches in height. Such devices may have a screen size in the range of 3 inches to 6 inches on diagonal. In some embodiments, dimensions for a tablet device may be in a range of 3 inches to 8 inches in width by 5 inches to 11 inches in height. Such devices may have a screen size in a range of 7 inches to 15 inches on diagonal. Techniques as described herein may allow multiple types of user interfaces to be incorporated into devices in those size ranges, even if some input modes are based on gestures made in three dimensional space near the device.

A user interface may provide both a means for a user to input information into the device and a means to output information to the user. Within the device, an interface driver within an operating system, or other suitable component, may process the outputs of the user interface and make it available for use by another component, such as an application, which may interpret the input information in context. For example, the output of a touch screen may indicate a position of one or more points of contact with the screen at each of multiple successive times. An interface driver may recognize based on the output from the touch screen that a user made a particular gesture. The driver may provide characteristics of the gesture to an application program, which may then respond appropriately.

For example, the operating system may recognize in the output of the touch screen an indication that a user made a “swipe” gesture, starting at a first identified location and ending at a second identified location, with a particular speed. This information may be presented to an application displaying data at the first identified location. The application may, in that context, interpret the swipe as navigational information, indicating that a different portion of the data is to be displayed. That application may obtain that different portion of the data and present it on the display screen, completing a response to the gesture input from the user.

In another example, the operating system may recognize in the output of the touchscreen an indication that a user touched a particular location on the screen. This information may be interpreted by the operating system to perform a particular action. When there is a virtual keyboard on the screen, a user may select a key on the keyboard by touching the location of the key on the screen. An application may interpret the touched location as keyboard input information, indicating that output information associated with the key is to be displayed, such as text like B or L. Additionally, a user may touch a location on the screen to select a link, such as to open an application or link. The operating system may interpret the touched location as navigational information, indicating that output information associated with touching the particular location is to be displayed.

Electronic devices may have multiple user interfaces. For example, a device may also have a keyboard. An interface driver or other suitable component may similarly process the outputs of the keyboard and provide that to an application or other component in the device. In this case, the operating system may determine which keys were activated by the user. Similarly, when a touch pad is present, an interface driver or other suitable component may receive the outputs of the touch pad and provide information, representing change of location of a point or points on the touch pad touched by the user. That information may be passed to an application or other component within the device.

Different user interfaces may provide different types of user input. Some inputs may be location-based. For example, a keyboard may provide input that depends on the location designated by the user. Those inputs may be textual because, on a keyboard, locations may correlate to specific text characters. Location-based input may also serve as navigational information, which may be interpreted to indicate to the device to perform a particular action and change the display according to such an action.

Other input may be gesture-based. Gesture-based input may serve as navigational information, which may be interpreted as a command to change the information display by navigating through a state-space associated with a data set that is correlated with directions of the gestures. Yet other gesture-based input may select or alter data or other information, including graphical objects, on the display. Some gesture-based input may be touch-based, meaning that the input reflects a point on the physical interface indicated, such as by touching. Other gesture-based input may be touchless, meaning that the input reflects position or motion indicated in a three dimensional space.

In some embodiments, the user interfaces may output indications of a detected user gesture regardless of whether the gesture is intended to be an input to that user interface. For example, a touchpad may be positioned adjacent a keyboard such that, when typing, a user may contact the touchpad, generating an unintended input to an application executing on the device. Thus, there is a risk of ambiguity when a gesture, intended by a user to represent an input through one user interface is alternatively or additionally interpreted by the device as input through a different user interface. As devices are made smaller and user interfaces become closer together, the risk of ambiguity may increase.

Further, the risk of ambiguity may increase as devices include more gesture-based user interfaces. Ambiguity may occur, for example, when, the electronic device has one or more sensors that are configured to detect a user gesture in a space near the electronic device. Such sensors may respond to a user moving their hands to type on a keyboard or activate a touch pad. Accordingly, a device may include one or more mechanisms to disambiguate outputs of multiple user interfaces.

The disambiguation mechanisms may include a mechanism by which a user may provide an input to the device to identify an intended input mode. Various mechanisms for a user to indicate an intended input mode are described herein. Such mechanisms may include an additional user interface, such as a button or jog wheel on the device. Alternatively or additionally, a gesture through an existing interface may signify an intended operating mode. For example, a user may press and hold a key for longer than some threshold amount of time, that is longer than a typical user might press a key while typing. Alternatively or additionally, a gesture may be made with the device, if the device is a portable device. For example, the tilt or acceleration of the device may signify a change in input mode or an intended input mode.

A device that distinguishes between input modes may alternatively or additionally include a mechanism to suppress the outputs of the sensors of the user interfaces that detect a user gesture. Any suitable approach may be used to suppress the outputs. Such suppression may occur within the hardware of the user interface, the drivers that control the user interface hardware or within the operating system or other component that processes the outputs of the user interface. In operation, one or more of these suppression mechanisms may operate to allow only inputs associated with user interfaces that generate meaningful output in the intended input mode to reach the application or other components that respond to the user inputs.

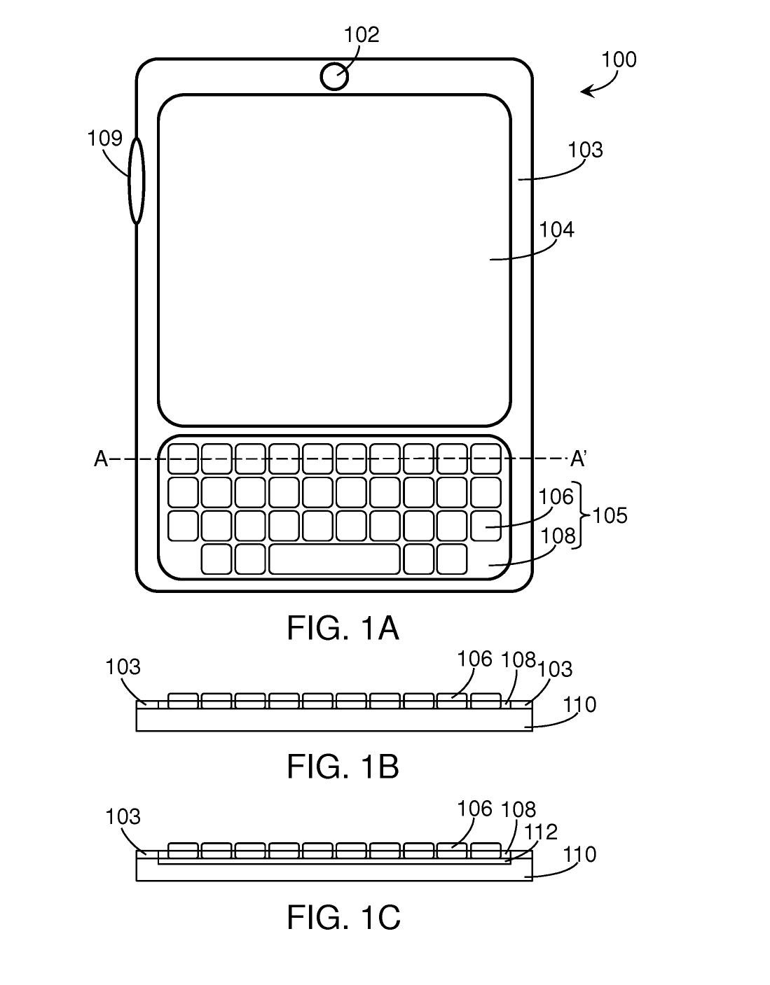

These mechanisms may be implemented in any suitable type of device, including a portable electronic device. Example embodiments of portable electronic devices will be described in reference to FIGS. 1A-C and 2A-C. FIG. 1A is a sketch of an electronic device 100 having a camera 102, a screen 104, a keyboard 105, a button 109, and a housing 103. The camera, the screen, the keyboard, and the button may be in any suitable locations and have any suitable dimensions. However, in the embodiment illustrated, the camera, the screen, and the keyboard are positioned on one surface of housing 103 such that a user may access all of these user interface components when the device 100 is held with that surface facing the user. In the illustrated embodiment, for example, a lens of camera 102 may be in that surface such that the camera may capture images of objects above that surface. In the illustrated embodiment, the button 109 is in the housing 103 on a side of the device to be accessible to a user's hand when holding the device.

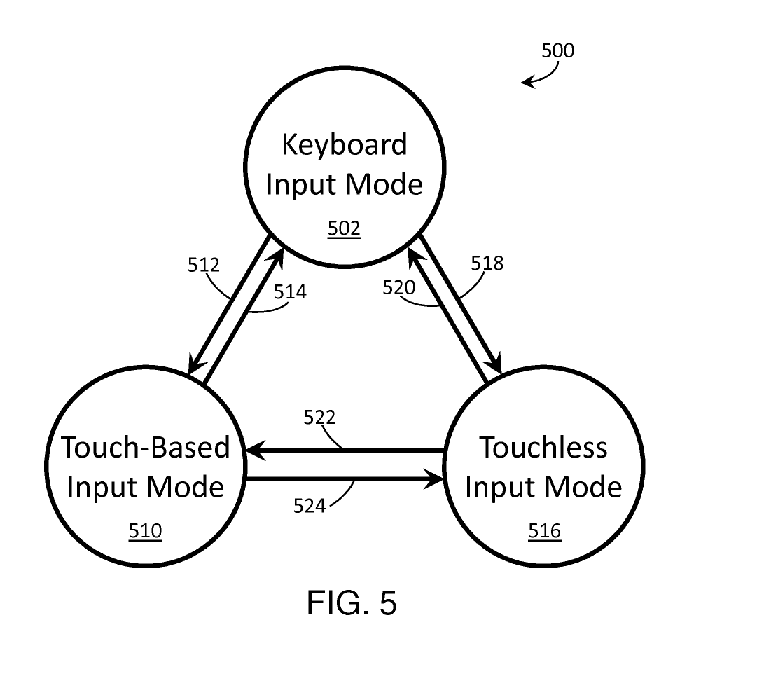

The user interface components may be implemented using technology as is known in the art. The keyboard 105 may include a keyboard structural layer 108 with keys 106. A user may use the keys 106 for text input into device 100. In the example shown in FIG. 1A, the keyboard is a physical keyboard. Though not expressly illustrated in FIG. 1A, the keys 106 may be coupled to interface circuitry (e.g. 560, FIG. 5) that produces output electrical signals representative of locations on the keyboard 105 contacted by a user.

In this case, the keys represent sensors that detect user interaction with the device, and the electrical signals output by the keyboard may depend on how the activation of the key “sensors” is interpreted. The form and significance of the electrical signals may depend on input modes supported by device and/or the input mode in which the device is operating. In some embodiments, the device may support only a keyboard input mode and the output electrical signals may indicate specific keys activated by the user. In other embodiments, the device may alternatively or additionally support a gesture-based input mode using the same keyboard sensors. In such an embodiment, when operated in a gesture-based input mode, the output electrical signals may indicate the raw locations at which the user contacted the keyboard or may indicate a gesture detected in a pattern of locations. For example, in a keyboard input mode, the output may indicate separate keys were struck in a sequence, such as S-D-F-G-H-J-K. In a gesture-based input mode, the same gesture might be represented in an output indication that the user swiped to the right on the keyboard.

The output from the keyboard 105 may be provided to a processing unit (e.g. 520, FIG. 5) for processing as appropriate for the input mode. It should be appreciated that translation of sensor outputs into information about user input may be performed in any suitable component. A keyboard interface component was given as an example of a component that may perform that processing. However, processing may be performed in the processing unit or other suitable component.

Moreover, the signals output from the keyboard may depend on the implementation of the keyboard. For example, the output may directly indicate a key activated. In a virtual keyboard, the output may indicate only locations at which the user contacts the keyboard, and subsequent processing may associate those locations with specific keys. Alternatively, the keyboard may be configured with structures that provide, separate from indications of which keys are activated, locations of contact with the keyboard. Such an alternative implementation is shown in FIG. 1C.

A plan view along line A-A′ is shown in FIG. 1B. That figure shows an underlying device layer 110 indicating a region of the device within housing 103 below the keyboard structural layer 108 and keys 106. In this embodiment, for example, each of the keys may be configured as a switch. Layer 110 may contain circuitry that detects when one of those switches is closed and produces an output indicating which switch was activated.

In some embodiments, there may alternatively or additionally be a layer underneath the keyboard. This layer may be used to detect activation of keys and/or to detect gesture-based input. FIG. 1C shows a plan view along line A-A′ where there is an additional layer 112 underneath the keyboard 105. The layer 112 may be a sensor or an array of sensors configured to receive gesture-based user input. That gesture-based input may be contacting or non-contacting input. Accordingly, sensors in layer 112 may sense contact with keyboard 105 or, in some embodiments, may detect presence or movement of objects in space above the keyboard.

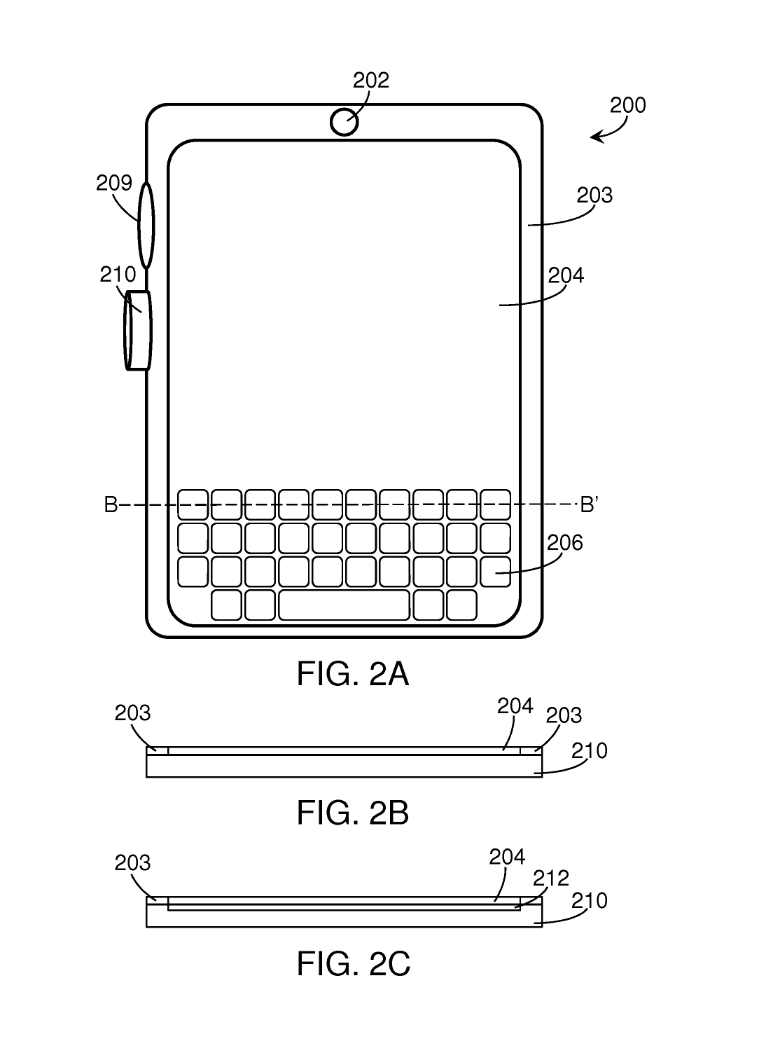

FIG. 2A is a schematic of an electronic device 200 having a camera 202, a screen 204, a button 209, and a jog wheel 210, and a housing 203. The camera, the screen, the button, the jog wheel, and the keys 206 of the virtual keyboard may be located in any suitable arrangement and may have any suitable size or shape. In the example shown in FIG. 2A, the keyboard is a virtual keyboard displayed on screen 204. The keyboard includes keys 206 which in this embodiment are implemented by displaying graphical icons on screen 204 of device 200.

A plan view along line B-B′ is shown in FIG. 2B and has an underlying layer 210 below the screen 204 and housing 203. Within layer 210, sensors may be positioned to detect a user gesture indicating a location on screen 204. In some embodiments, these sensors may be pressure sensors, or other sensors that detect actual contact with screen 204.

Sensors may be distributed across screen 204 and interconnected by transparent conductors, or in any other suitable way, to an interface component. The interconnections may be such that the interface component can determine which sensor responded to contact, allowing the location of the contact on screen 204 to be determined from the location of a sensor that responded to the contact. However, it is not a requirement that the sensors in layer 210 be distributed evenly under screen 204. Sensors within layer 210, for example, may be distributed around the perimeter of the screen 204. These sensors may detect distortion or tilt of a transparent sheet forming a top layer of screen 204. An interface component may determine the location of contact on screen 204 based on a triangulation approach that uses the relative strength of signals output by multiple sensors to compute a location.

Contact-based sensors may be implemented with an array of capacitive elements on an insulator. In an embodiment with a physical keyboard, the capacitive elements may cover the full area of the keyboard or a portion of the keyboard. In an embodiment with a virtual keyboard, the capacitive elements may cover all or a portion of a surface, such as screen 204, through which input may be provided. A user's body may serve as a source or sink of electrical charge, and the touch of a user's body may alter the charge on the capacitive elements. The change in charge may produce a measurable change in voltage at the capacitive elements in the region the user touched. A user interface component may respond to such a change in voltage and send a signal, representative of the user input, for processing within the electronic device.

In some embodiments, the contact-based sensor may be an array of resistive elements. As with capacitive elements, the resistive elements may cover all or a portion of a surface through which user input may be provided. When an object, such as a user's finger, presses down on a region of the surface of the device, the resistance of the resistive elements may change, causing a change in electrical current that can be detected and associated with a location on the user interface. However, it should be appreciated that any suitable sensor capable of detecting contact may be used.

The same or different contact sensors may be used to designate different types of input, in a location-based input mode, to detect a location designated by the user on a surface of the device. For example, the surface of the device may be a display and the user activity may be intended as navigational information. When the user designates a location on the display having a virtual keyboard, the user activity may be intended as keyboard input information. The surface may also be a physical keyboard and the user activity may be intended as providing keyboard input information.

The same or different contact sensors may be used, in gesture-based input mode, to detect gestures made by the user in contact with a surface of the device, but may nonetheless be intended as providing navigational information or otherwise be gesture-based input. The surface of the device may be a display. Additionally, the surface of the device may be a physical keyboard.

Alternatively or additionally, layer 210 may include non-contact sensors. Non-contact sensors may respond to objects, such as a user's fingers or hand, above screen 204. These non-contact sensors may be very short range, detecting the presence of the user's finger or hand only when in close proximity to the screen. Sensors, for example, may detect a finger that is less than 10 mm from the surface. Non-contact sensors that operate over such a short range may, on some embodiments, may operate like contact sensors, detecting locations on the screen indicated by a user gesture.

Alternatively or additionally, the non-contact sensors may operate over a longer range, such as more than 10 mm from the surface. Such non-contact sensors may detect an object, such as a user's hand or fingers in a range up to 10 cm from the surface, in some embodiments, In other embodiments, the range may be greater, such as up to 25 cm, 35 cm or 50 cm, for example. Such non-contact sensors may detect gestures in three dimensional space above the screen.

Non-contact sensors may be implemented with any suitable technology, such as phototransistors, which may respond to a shadow or a reflection as an object passes over screen 204. As another example, non-contact sensors may sense an electric field associated with a charged object moving near surface 204. As yet a further example, camera 202 may serve as a non-contact sensor. Image processing software may analyze a sequence of image frames captured by camera 202 to identify an object, such as a user's hand, above surface 204. By tracking location from frame to frame, motion of the object, and therefore a gesture made by the user, may be ascertained.

In some embodiments, a non-contact sensor may be an optical sensor or an array of optical sensors. Such optical sensors may include cameras, phototransistors, or any other suitable optical sensor, including those known in the art. In such embodiments, light, or other radiation, may be emitted near a surface of the device, and radiation reflected from the object may be received by the sensors. The light may be from any suitable light-emitting device known in the art, such as lasers, light-emitting diodes or LEDs. The LEDs may emit infrared light. Alternatively or additionally, light or other radiation may come from the ambient environment.

In some embodiments, sensors may be positioned to receive radiation from the source when an object is not present. In such embodiments, when an object, such as a user's hand, moves in the path of the light, the object obstructs the beam and blocks radiation from reaching the sensor. An optical sensor or an array of optical sensors may detect the absence of light and transmit an output signal. The location of the optical sensors and the signal identifies the coordinates of the location of the object. Such an output signal may be interpreted as navigation information by an operating system, application, and/or program on the device. In some embodiments, a circuit controller board may receive output signals from the optical sensors. The software of the controller may determine the position of the touching object and send this information to the operating system.

In some embodiments, the non-contact sensor may be a camera. The camera may be mounted on the device and positioned to acquire input signal from a three-dimensional interaction space over a surface of the device. Such a surface may be a keyboard integrated as part of the device. Additionally or alternatively, the surface may be a portion of the screen or the display of the device. The images acquired by the camera may be processed using edge-detection techniques known in the art to determine the user's position in space. Additionally, the images acquired by the camera may be analyzed by a processor using gesture recognition algorithms to approximate the nature of the user's gesture. The processor may send an output to an operating system, application, and/or program of the device. In response, such a component may update a graphical user interface of the device based on the received user input.

In some embodiments, the non-contact sensor may operate by sensing an electric field. In such embodiments, a moving object may cause perturbations in the electric field detected by the sensor. An electric field apparatus may be located underneath the keyboard. As an example, an electric field apparatus may be located within layer 112 underneath the keyboard 105 shown in FIG. 1C. In another example, the electric field apparatus may be located within layer 212 that lies underneath screen 204 of the device shown in FIG. 2C. Additionally or alternatively, the electric field apparatus may be located within the keyboard structure. In such embodiments, the electric field apparatus may be within the keyboard 105 or the keyboard structure layer of 108 shown in FIG. 1B. In other embodiments, the electric field apparatus may be located within the screen 204 of the device shown in FIG. 2B.

The electric field apparatus may include sensing and/or transmitting electrodes. Such transmitting electrodes may transmit an AC signal into a three-dimensional interaction space. The AC signal may be at a low power. The frequency of the AC signal may be an ultrasonic frequency. The frequency of the AC signal may be around 50 kHz.

The electric field apparatus may include a set of receiving electrodes. The set of receiving electrodes may be configured to receive the AC signal transmitted by the transmitting electrodes. When a user moves into the three-dimensional space, the transmitted AC signal may be distorted, blocked, reflected or otherwise perturbed. As a result of user action, the AC signal may be changed in some measurable characteristic, such as amplitude, frequency, and/or phase of the AC signal. The user-distorted AC signal may be received by the receiving electrodes and an indication of the change in the signal sent to an interface component. The interface component may interpret the change to determine the nature of the user's gesture. The interface component may output an indication of the detected gesture, which may be sent to the operating system, application, and/or program where the operating system may use the interpreted AC signal output to update a graphical user interface.

In embodiments with non-contact sensors, a user does not need to contact screen 204 to activate a key on the virtual keyboard. Rather, user gestures made above screen 204 may be recognized as indicating keys on the virtual keyboard, even if the user never contacts screen 204. In this way, output from the non-contact sensors may be used, in a keyboard input mode, to identify keys on the virtual keyboard activated by the user.

The same or different non-contact sensors may be used, in a gesture-based input mode, to detect gestures made by the user in the space above the device. Those gestures may involve contact with the surface 204, but may nonetheless be intended as providing navigational information or otherwise be gesture-based input.

Gestures may involve motion in a three-dimensional space above surface 204. The three-dimensional space in which a user may form a gesture may be any suitable shape, which may be determined by the range and operation of sensors. In some embodiments the three-dimensional shape may be a hemisphere. The three-dimensional shape may also be a conical shape. It is within this region a user may form a gesture to be interpreted as input by the electronic device.

Such gesture recognition offers the ability for the user to provide an input to an electronic device without obstructing the screen while making the gesture. In addition, in embodiments in which the sensors do not require line of sight, gestures may be performed when the electronic device is not directly visible to a user. Such gesture recognition techniques may allow, for example, the user to provide input to an electronic device when the device is in a user's pocket or bag.

In some embodiments, the non-contact sensors may be located within the structure of the keyboard. As in the example shown in FIG. 1B, the non-contact sensors may be in the keyboard 105 or the keyboard structure layer 108. As in the example shown in FIG. 2B, the non-contact sensors may be any portion of the screen 204. In some embodiments the non-contact sensors may be the portion of screen 204 where the virtual keyboard is located. In some embodiments, the non-contact sensors may be separate from sensors that respond to contact on surface 204.

In some embodiments, the non-contact sensors may be located underneath the structure of the keyboard. As in the example shown in FIG. 1C, the non-contact sensors may be in the layer 112 underneath a physical keyboard. In some embodiments, the non-contact sensors may be located underneath the screen of a virtual keyboard as in layer 212 shown in FIG. 2C. The layer 212 may be a sensor or an array of non-contact sensors configured to receive navigational user input.

Regardless of the technology used to implement the sensors, the outputs of the sensors may be processed to determine an intended user input associated with a detected gesture. In a keyboard input mode, sensor outputs may be correlated with keys on the keyboard. In a gesture-based input mode, sensor outputs may be correlated with a gesture, such as a “swipe” or “pinch.”

The input mode may be determined in any suitable way. In some embodiments, a separate user interface may be provided. In the embodiment of FIG. 2A, device 200 includes a button 209 and a jog wheel 210. As with the embodiment of FIG. 1A, pressing button 209 may set or change the input mode. Alternatively or additionally, rotating or pressing jog wheel 210 may set or change the input mode.

Although an integrated screen is shown in the examples of FIGS. 1A and 2A, any suitable screen or display device may be used. In some embodiments, the screen may be a separate, independent device that receives output signals from a processing component of the electronic device. The screen, even if separate from the electronic device, may also receive user input and send output to the processing component of the portable electronic device. Signals may be sent and/or received through wired communication techniques known in the art. Additionally or alternatively, signals may be sent and/or received via wireless communications, such as radio, wireless internet network, Bluetooth, and wireless USB.

In some embodiments, an independent screen device may be worn by an individual. In some embodiments, the independent screen device may be mountable to an object and/or surface. In such embodiments, a heads-up display may be used. Such a heads-up display may be mounted on the windshield of an automobile or worn like a pair of eyeglasses, for example. Regardless of the type and form of the screen, a processor of an electronic device may present information on the screen that is impacted by gestures acting as user input. The specific manner in which a user gesture impacts what appears on the screen, may depend on the input mode in which the electronic device is operating.

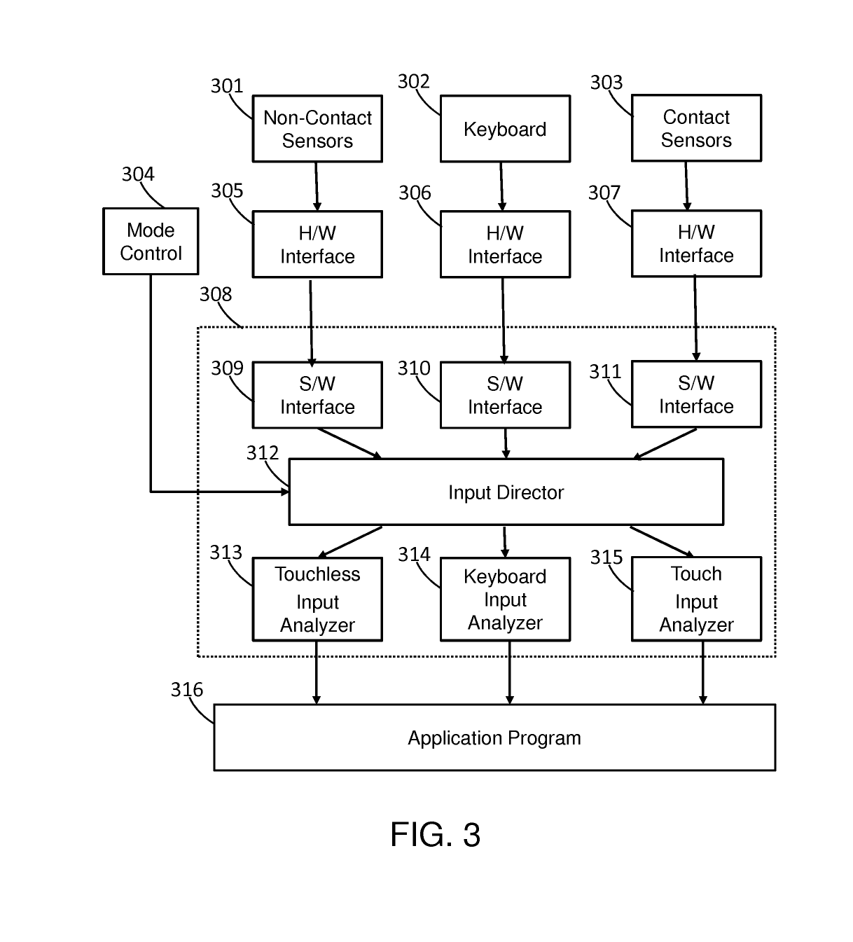

Interpreting user input signals to remove ambiguity may be performed in any suitable manner. FIG. 3 illustrates example components of an electronic device that may be involved in acquiring an input signal from a user, interpreting that signal, and sending the interpreted signal to an application and/or program that responds to the interpreted signal in context established by that application and/or program.

In the example of FIG. 3, the device has multiple user interfaces. User input into the device illustrated in FIG. 3 may be in the form of non-contact sensors 301, a keyboard 302, and contact sensors 303, such as those described in the present invention. The non-contact sensors, keyboard, and contact sensors have hardware interfaces, 305, 306, and 307, respectively that are configured to receive a user input signal from its associated sensing user interface. These sensors and hardware interfaces, for example, may correspond to non-contact sensors detecting user motions in the three dimensional space above the device, a keyboard and a touch pad. It should be appreciated, however, that such sensors and hardware interfaces may correspond to any suitable interfaces. Moreover, in some embodiments, only a subset of such user interfaces may be present. In other embodiments, other user interfaces may be present. These sensors and hardware interfaces may be implemented using technology known in the art or in any other suitable way.

The hardware interfaces transmit the input signal to associated software interfaces (309, 310, and 311). The software interfaces may be part of the operating system 308 of the device. The software interfaces may be drivers of the operating system in order for the electronic device to send and receive information between the hardware interfaces and the operating system of the device. Such drivers may be implemented using technology known in the art or in any other suitable way. Each software interface may be configured to transmit the user input signal to an input director 312.

The input director may be part of operating system 308. It may operate to ensure that outputs of the user interfaces are interpreted as intended by a user based on the input mode. As shown, input director 312 receives input indicating a user selected input mode. In this example, that input is received from mode control component 304, which may be a button or jog wheel, as described above. However, mode control component 304 may be, include or access information from any suitable component to identify an intended input mode.

Based on which input mode the user has selected, input director may pass or suppress the outputs of one or more of the sensors to one or more analyzers. For example, input director 312 may send the input signal received from non-contact sensors 301 to touchless input analyzer 313 in a mode in which the user may provide input by making a gesture in a space adjacent the device. Input director 312 may send the input signal received from keyboard 302 to keyboard input analyzer 314 in a mode in which the user may provide input by activating specific keys. Input director 312 may send the input signal received from contact sensors 303 to touch input analyzer 315 in a mode in which the user may provide input by moving a point of contact across a touch pad.

However, it should be appreciated that in some embodiments, outputs of the same sensor may be routed to different ones of the analyzers in different modes. For example, in an embodiment in which a device has a touchscreen interface with contact sensors 303 and no keyboard, output of the contact sensors 303 may be routed to keyboard input analyzer 314 in a keyboard input mode and to touch input analyzer in a contacting, gesture-based input mode and/or a location-based input mode. Such an input director 312 may be implemented with programming in the operating system, using programming techniques known in the art, or in any other suitable way.

The analyzers may interpret the user input signal as appropriate for the input modes in which they are operative. Each analyzer may send an output signal, representative of a detected gesture, to an application program 316. For example, keyboard input analyzer may output indications that the user has made gestures indicate a particular location on the device and corresponding to typing specific keys or key sequences. Touch input analyzer 315 may output indications that the user has made a gesture by moving a point of contact with the device. The output may indicate the nature of the gesture, such as pinch, swipe, select, drag, or other gestures now known or hereafter developed. Touchless input analyzer 313 may output indications of gestures that include motion in a space near the device. For example, touchless input analyzer 313 may determine, from a stream of outputs of non-contact sensors 301, that a user has moved their hand slowly from left to right or from a larger distance from the screen to a smaller distance from the screen.

In some embodiments, the outputs of keyboard input analyzer 314 and touch input analyzer 315, in modes in which those analyzers are active, may be used like outputs from a conventional keyboard interface or touch pad interface. The output of touchless input analyzer 313, when provided to application program 316, may be interpreted as navigational information, or in any other suitable way. A left to right gesture, for example, when interpreted as navigational information may be interpreted as a command to pan right. A far to near gesture may be interpreted as a command to zoom in. Other motions may be interpreted as other commands.

The application program may then update a graphical user interface based on context and a meaning ascribed to a detected gesture.

Using the techniques described herein, a device may support multiple input modes, such as a keyboard input mode, a navigational input mode, a location-based input mode, and/or a gesture-based input mode. Such a device may include a physical keyboard integrated into the device as shown in the device 100 of FIG. 1A. The keyboard may be virtual keyboard where the keys are displayed on the screen of the device as shown in the device 200 of FIG. 2A. Location-based input, gesture-based input, and navigational input may be provided from the user using any one or a combination of the contact-based and/or non-contact based techniques described herein. Location-based input may be available to a user in a location-based input mode. Gesture-based input may be available to a user in a gesture-based input mode. Navigational input may be available to a user in a navigational input mode. In some embodiments, a device may support both a keyboard input mode and a navigational input mode. In some embodiments, a device may support both a location-based input mode and a gesture-based input mode.

In some embodiments, the device elements used to detect keyboard input information, navigational input information, location-based input information, gesture-based information from the user may be the same and/or respond to gestures in overlapping spaces. In such embodiments, an output signal from an input sensor may be misinterpreted by an operating system because the output signal may have more than one possible meaning, depending on which sensor the user intended to activate. The meaning of the signal may be ambiguous, for example, because it could either have been intended to trigger keyboard input or navigation input. To remove such ambiguity, designated input modes may be formulated in order for the operating system to correctly interpret the meaning of the signal. One or more user predefined actions with respect to the device may specify the input mode, allowing a user to select and change the input mode as the user interacts with the device.

Such input modes may include a keyboard input mode, a navigational input mode, a location-based input mode, and a gesture-based input mode. Those modes, for example, may be suitable for use in a device with a keyboard, whether physical or virtual, and one or more non-contact sensors. A user may select the keyboard input mode to signal to the operating system to process output from the keyboard as indications that the user has activated keys. Keyboard input mode may also signal to the operating system to suppress processing of the outputs of the non-contact sensors, as any output of those sensors may be false signals, triggered by the user moving their hands to access the keyboard rather than the user making a gesture in the space about the device intended as an input. Conversely, a user may select the navigational input mode to signal to the operating system to process outputs of the non-contact sensors as navigational information.

Designating input modes for either keyboard, navigation, location-based, or gesture-based operation allows the operating system to correctly interpret the outputs of the sensors. In some embodiments, the navigational input mode and the keyboard input mode may be mutually exclusive. In some embodiments, keyboard outputs may be suppressed in navigational input mode. In other embodiments, keyboard outputs may be processed in navigational input mode. In some embodiments, the location-based input mode and the keyboard input mode may be mutually exclusive. In some embodiments, location-based outputs may be suppressed in gesture-based input mode. In other embodiments, location-based outputs may be processed in gesture-based input mode. Additionally or alternatively, the operating system may correctly interpret outputs of the sensors in different input modes As an example, when a user designates a key on a keyboard, an output from the keyboard may be correctly interpreted by both the location-based input mode and the keyboard input mode. As an example in which the input modes are mutually exclusive, an integrated keyboard on a device may have both an input mode designed for keyboard input information where the keys of the keyboard are used for their identified function and a navigational input mode where the user may use the keyboard surface to provide navigational input information. In such an example, the keyboard may receive a particular user signal, which may have more than one interpretation by the operating system, depending on the input mode selected. For an example, a user may touch the keys in a specific sequence. The sequence of keys may correspond to a user specified keyboard input or navigational information by the user. If the desired input mode is not clearly identified by the device, then misinterpretation of the signal may occur. Such misinterpretation may lead the user to perceive errors in the operation of the device. To reduce misinterpretation of such a signal, a user may activate a specified input mode to signal to the operating system the user's intended input mode.

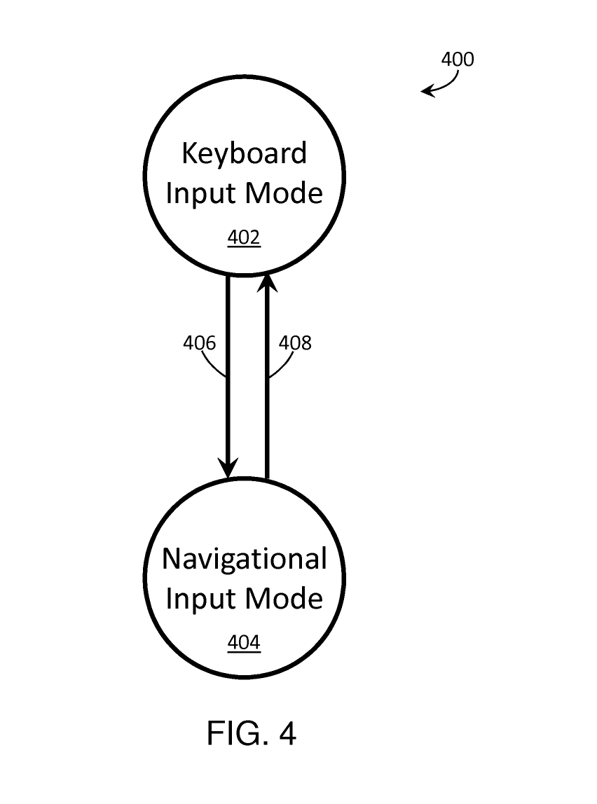

Having input modes, and allowing user action to control which mode is operational at any time disambiguates inputs to avoid errors. FIG. 4 is a state diagram 400 showing two input modes for a device and transitions between the two modes. In this example, the two user input modes are a keyboard input mode 402 and a navigational input mode 404. In this example, the keyboard input mode and the navigational input mode do not occur at the same time or are mutually exclusive. These input modes may be implemented in any suitable way, including by selectively processing sensor outputs by an interface component or by software executing within a device, as described herein.

Transition 406 occurs in response to any trigger indicating the navigational input mode. Transition 408 occurs in response to any trigger indicating the keyboard input mode. These triggers may be the result of express or inferred user input. Express input, for example, may be a user rotating or pressing a jog wheel or button. Alternatively, the user moving the device in a predefined direction or with a predefined acceleration may trigger a change in mode. However, any suitable action that may be detected may designate a desired input mode. Alternatively or additionally, the input mode may be inferred from context. A program expecting user input to provide navigational information may signal to the operating system to enter navigation input mode. Conversely, a program expecting user input to provide keyboard input may signal to the operating system to enter keyboard input mode. However, any suitable trigger may be used to change between input modes.

It should be appreciated that FIG. 4 represents only one possible combination of user input modes that may be implemented in a device. In some embodiments, a touch-based navigational input mode and a touchless gesture recognition navigational input mode may be used. Additionally or alternatively, either or both of the navigational input modes may be combined with a keyboard input mode. Such designated user input modes reduce and/or remove ambiguity or misinterpretation of a signal that may have multiple interpretations. Having two separate navigational input modes: a touch-based and a touchless input mode may be used when the detection elements for both forms of input are the same and/or overlap. For an example, the user may occupy a similar three-dimensional space when providing navigational input to the device, regardless of whether it is touch-based or touchless. The operating system will interpret the signals output by the sensors based on whether the device is in the touch-based or the touchless navigational input mode.

FIG. 5 is a schematic of a state diagram 500 showing transitions between three input modes. The three user input modes include a keyboard input mode 502, a touch-based input mode 510, and a touchless input mode 516. In a device programmed to operate in accord with the state diagram of FIG. 5, there may be different mechanisms for the user to select the different input modes. The mechanisms may be different depending on the mode in which the device is operating and the mode into which the device is to transition. The keyboard input mode 502 may be selected from the touch-based input mode 510 by triggering transition 514 and the touchless input mode by transition 520. The touch-based input mode 510 may be selected from the keyboard input mode 502 by triggering transition 512 and from the touchless input mode 516 by triggering transition 522. The touchless input mode 516 may be selected from the keyboard input mode 502 by triggering transition 518 and the touch-based input mode 516 by triggering transition 524.

In some embodiments, the selection mechanism for a particular input mode is independent of the mode currently selected. As an example, the trigger for transition 512 may be the same as the trigger for transition 522, as either transition results in the device operation in touch-based input mode 510. For selecting the keyboard input mode, transition 514 may be triggered by the same events as transition 520. For selecting the touchless input mode, the triggers for transition 524 may be the same as triggers for transition 518. However, there is no requirement that the transitions out of different modes be the same, and in some embodiments it may be preferable to have different triggers. For example, to transition from touchless input mode 516 to touch-based input mode 510, a predefined gesture may serve as a trigger. Such a gesture may not be used to trigger a transition from keyboard input mode to touch-based input mode 510 because the outputs of non-contact sensors may be suppressed in keyboard input mode 502 and such a gesture may not be recognized.

In other embodiments, sensor outputs, though suppressed from being supplied to executing programs within the device, may still be received and could be processed, such as input director 312. For example, keyboard output could be used to specify a mode regardless of current input mode. As such, the trigger used to select a particular input mode may be pressing keys on the keyboard. The key may be a modifier key, such as Alt or Shift. The key may be an alphanumeric key, including alphabetical, numeric, and punctuation keys. Such alphanumeric keys may include A, 1, #, or the Space key. In some embodiments, the selection method may be pressing more than one key. In such embodiments, a sequence of keys may be used to select an input mode for the device.

Different aspects of how the key is pressed may be part of the selection method for a particular input mode. As an example, the duration of the key press may signify a particular input mode. The duration may be momentary. A momentary press may be the time taken for a user to press the key under typical typing situations. Such a momentary press may be around 0.1 second or less than some threshold, such as 1 sec. An input selection method may be pressing a key with multiple momentary presses. In some embodiments, the duration may correspond to a long press. A long press may be to hold a key pressed for a duration of time that is longer than a momentary press. As an example, a long press may be three times a momentary press. Such a long press may be around 3 seconds. A momentary press and/or a long press technique may be used for a selection method where more than one key is used. Additionally or alternatively, the selection method may be a combination of a momentary press and a long press. As an example, pressing one key for a long press while another key is momentarily pressed may select an input mode.

In some embodiments, a component not on the keyboard may be used to provide input designating an input mode. Such a component may reside elsewhere on the device, for an example on a side of the device other than where the screen is located. While a key is described, any other suitable method known in the art capable of controlling a user selection may be used, such as a push button, a slide button, a switch, or a jog wheel.

Selecting an input mode may be done via a movement of a user with respect to the device. Such a movement may be a gesture by a user and registered by the device. The signal produced by the gesture is interpreted by the operating system to select a specific user input mode. Subsequent gestures or keyboard entries may be interpreted within the designated input mode. The user gesture to signal a change in input mode may occur at a specific velocity. The velocity of the gesture indicating a change in user input may be more than the velocity of a typical user gesture while using the touchless input mode. Additionally or alternatively, the velocity of the gesture may be less than the typical user gesture. As an example, when a user is operating the device in touchless input mode the user may perform a gesture to indicate a selection of another input mode, such as the keyboard input mode. Such a gesture may be the user placing their hand close to a gesture-sensing camera and then moving their hand quickly away. The camera measures luminance as a function of time and such a gesture would produce a signal based on the value of the first derivative of luminance. When the first derivative of luminance beyond a certain threshold is measured, a signal is produced to indicate to the operating system to select a specific input mode. In some embodiments, such a gesture would trigger transition 520 in FIG. 5 and select the keyboard input mode.

As further examples, the input mode may be selected via a movement of the device. Such a movement may be measured by an accelerometer in the device. The accelerometer may measure the rate of change of velocity of the device. When used to select an input mode, there may be a specific acceleration measured by the accelerometer that signals the operating system to select an input mode. Additionally or alternatively, if the acceleration measured by the accelerometer is equal to or above a threshold value, then this may signal to the operating system to interpret subsequent signals in a selected input mode.

In some embodiments, the method of selecting an input mode may be based on the angle of inclination of the device. Such an angle of inclination may be measured by a gyroscope in the device. When a specific angle on inclination is measured, then a signal is sent to the operating system to select a specific input mode. Additionally or alternatively, if the angle of inclination measured is equal to or above a threshold value, then this may signal to the operating system to select a specific input mode.

In some embodiments, the distance of the user from the device may be used to select an input mode. The distance of the user from the device may be sensed by a non-contact sensor, such as sensors as previously described. Such a technique may be used in switching between the touch-based input mode and the touchless input mode. As an example, when the user is in close proximity to the device's surface, the touch-based input mode may be selected. As the user moves further away from the device, there is a distance beyond which the touchless input mode may be selected by the device.

In some embodiments, a duration of time in the absence of user activity may trigger a transition to a specific user input mode. Such a transition may be triggered by the operating system without express user input. The duration of time may be measured by using a timer in the device. Such a timer may be set when an input mode is selected. If no user input to the device is registered before the timer expires, an input mode transition may be triggered. Such an approach may allow a default input mode to which the device returns. Such an approach may ensure the device is operating in a known input mode each time a user begins to operate it. Moreover, a default may serve as an error correction mechanism, if a user inadvertently places the device in an input mode such that the user is not providing inputs appropriate for that mode. A timeout, if no valid inputs are detected, may allow recovery from this situation.

In some embodiments, the keyboard input mode may be selected after a duration of time has passed. In such embodiments, if the touch-based input mode or touchless input mode are selected, then an input mode timer is set. The user may provide input to the device via touch-based input or touchless input. After the user stops performing activity, then the timer may expire and the operating system may select the keyboard input mode. Such a technique may allow a default mode to be selected. Additionally or alternatively, once the timer is initiated it may be reset when the user resumes providing input to the device under the currently selected input mode. Such input may include touching the device in the touch-based input mode or gesturing in the touchless input mode. Events resetting the time may be limited to detection of gestures that constitute valid inputs in the currently selected mode.

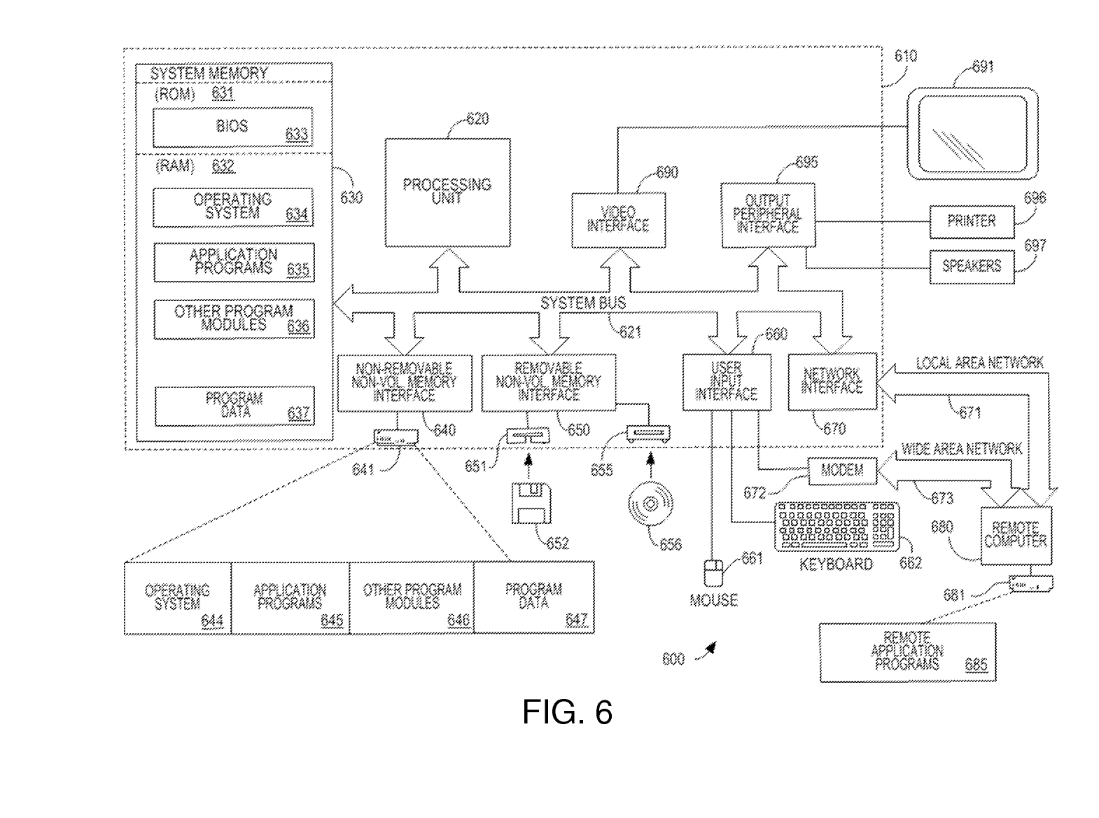

Multiple input modes may be implemented in any desired electronic device. By way of example and not limitation, FIG. 6 illustrates a suitable computing system environment 600 on which multiple input modes may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the invention includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as information impressed on a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through an non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

For example, embodiments are described in which outputs of user interfaces are processed by an operating system and then passed to applications executing within a computing device. It should be appreciated that the outputs of the user interfaces may be processed by any suitable component or may be processed in multiple components, which may include software or hardware components. For example, a touch screen, keyboard or touch pad may have a controller chip in which some or all of the processing associated with a signal generated based on user action is processed before information represented by the processed signal is passed to the operating system. Alternatively, outputs of a user interface may be passed directly to an application. As yet another possible variation, user inputs received through a user interface may control components within the operating system without being passed to any operating system.

As another example, a device may have more than one camera.

As yet another example of possible variations, electronic devices using a screen as an output mechanism were described. Should be appreciated that an electronic device may alternatively or additionally have other output mechanisms, including print or audible output mechanisms.

Further, it was described that gestures made by a user involve detection of motion. The gesture detected by a device may be dynamic or static. The “gesture,” for example, may be the user placing a hand or finger in a particular location.

Additionally, a three-dimensional space in which gestures may be detected may include the surface of the keyboard. In such embodiments, a user gesture may involve the user touching a surface in addition to making some motion in a three-dimensional space over the surface. Such gestures may be described as both being non-contact based and contact-based. Accordingly, while examples are given of output of a single sensor or multiple sensors of a single type being used to detect a gesture, the invention is not so limited. A device as illustrated in FIG. 3, for example, may include an analyzer that processes outputs of sensors of multiple types to ascertain a user gesture.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

The phraseology and terminology used herein is for the purpose of description and should not be regarded as limiting. The use of “including,” “comprising,” “having,” “containing”, “involving”, and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements from each other.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of selecting an input mode for an electronic device operable in a plurality of input modes, the electronic device having a display, the method comprising:
selecting an input mode of the plurality of input modes based on a user input, wherein the plurality of input modes comprises a location-based input mode and a gesture-based input mode;
responding, selectively, to a user activity based on the selected mode, the responding comprising:
when the location-based input mode is selected and the user activity designates a location on the device, modifying information presented on the display based on designated location information associated with the user activity; and
when the gesture-based input mode is selected and the user activity is a gesture detected by a sensor, modifying information presented on the display based on generated sensor output information associated with the user activity.

2. The method of claim 1, the method further comprising:
deselecting the location-based input mode when the gesture-based input mode is selected.

3. The method of claim 1, wherein the location-based input mode and the gesture-based input mode are mutually exclusive.

4. The method of claim 1, wherein the device has a keyboard, the method further comprising:
generating keyboard output information based on the user designating a key of a plurality of keys on the keyboard while in the location-based input mode; and
generating navigational information based on the user gesturing on a surface of the keyboard while in the gesture-based input mode.

5. The method of claim 4, wherein the user input is a pressing of at least one key on the keyboard exceeding a threshold time.

6. The method of claim 1, wherein the user input is received through a component residing on the device external to the keyboard.

7. The method of claim 1, wherein the user input comprises a movement of the electronic device.

8. The method of claim 1, wherein the user input comprises moving the electronic device to have a tilt with respect to an inertial coordinate system in a predetermined range of angles.

9. The method of claim 1, the method further comprising:
selecting, after a predetermined time, a second input mode of the plurality of input modes.

10. An electronic device associated with a display, the electronic device comprising:
a keyboard comprising a plurality of keys, the keyboard being configured to generate keyboard output information based on a user making a gesture designating a key of the plurality of keys;
at least one sensor configured to generate sensor output information based on a user making a gesture on a surface of the device; and
at least one processor configured to:
based on mode-indicating input received from the user, select an operating mode of a plurality of operating modes, wherein the plurality of operating modes comprises a keyboard input mode and a navigation mode;
selectively respond to a user gesture based on the selected mode, comprising:
when the keyboard input mode is selected, modify information presented on the display based on generated keyboard output information associated with the user gesture; and
when the navigation mode is selected, modify the information presented on the display based on sensor output information associated with the user gesture.

11. The device of claim 10, wherein the at least one sensor comprises at least one touch-based sensor and the at least one processor is further configured to generate navigational information based on the user touching the keyboard while in the navigation mode.

12. The device of claim 10, wherein the at least one processor is further configured to receive the mode-indicating input via at least one key on the keyboard.

13. The device of claim 10, wherein the at least one processor is further configured to receive the mode-indicating input via at least one button residing on the device external to the keyboard.

14. The device of claim 10, wherein the at least one processor is further configured to deselect the keyboard input mode when the navigation mode is selected.

15. The device of claim 10, wherein the keyboard input mode and the navigation mode are mutually exclusive.

16. The device of claim 10, wherein the keyboard is on a surface of the device and the at least one sensor is within the device adjacent to the keyboard.

17. The device of claim 10, wherein the at least one sensor is within the keyboard.

18. The device of claim 10, wherein the at least one sensor comprises at least one of a plurality of resistive elements, a plurality of optical elements, and a plurality of capacitive elements.

19. The device of claim 10, wherein the display is a screen mounted on the device.

20. The device of claim 10, wherein the display is a separate device.

21. The device of claim 20, wherein the display is configured to be worn by a user.

22. The device of claim 20, wherein the display is a heads-up display.

23. The device of claim 10, wherein the keyboard is a physical keyboard.

24. The device of claim 10, wherein the keyboard is a virtual keyboard.

25. The device of claim 10, wherein the at least one sensor is integrally connected to the keyboard.

26. The device of claim 10, wherein the electronic device is a smartphone.

27. The device of claim 10, wherein the electronic device is a tablet.

28. The device of claim 10, wherein:
the electronic device further comprises an inertial sensor; and
the mode-indicating input comprises an output of the inertial sensor.

29. The device of claim 10, wherein:
the at least one processor is further configured to select a default input mode after a duration of time based on a timer;
the default input mode is set to at least one of the keyboard input mode and the navigation mode; and
the timer is reset when at least one of the keyboard input mode and the navigation mode is selected by mode-indicating input received by the user.

30. At least one non-transitory, tangible computer readable storage medium having computer-executable instructions, that when executed by a processor, perform a method of selecting an input mode for an electronic device operable in a plurality of input modes, the electronic device having a keyboard and a display, the method comprising:
selecting an input mode of the plurality of input modes based on a user input, wherein the plurality of input modes comprises a location-based input mode and a navigation mode;
responding, selectively, to a user gesture based on the selected mode, the responding comprising:
when the location-based input mode is selected, modifying information presented on the display based on designated location information associated with the user gesture; and
when the navigation mode is selected, modifying information presented on the display based on navigational sensor output information associated with the user gesture.

31. The method of claim 30, wherein the designated location information and the navigational sensor output information is based on the user touching the keyboard.

32. The method of claim 30, wherein the generated location output information is keyboard output information based on the user gesture designating a key of a plurality of keys on the keyboard while in the location-based input mode.

33. The method of claim 30, wherein the generated navigational sensor output information is based on the user gesture made on a surface of a keyboard associated with the device while in the navigation mode.

34. The method of claim 30, wherein the user input is a pressing of at least one key on the keyboard exceeding a threshold time.

35. The method of claim 30, wherein the user input is received through a component residing on the device external to the keyboard.
